(19) United States
(12) Patent Application Publication
(10) Pub. No.: US 2006/0224777 A1
(43) Pub. Date: Oct. 5, 2006

(54) System and method for creating test data for data driven software systems

(75) Inventors: Anne R. Sand, Peyton, CO (US); Leah R. Smutzer, Rochester, MN (US); Richard J. Stevens, Rochester, MN (US); Jingdong Sun, Rochester, MN (US); Paul W. Wertzler, Rochester, MN (US)

Correspondence Address: IBM CORPORATION;DEPT 917, 3605 HIGHWAY 52 NORTH, ROCHESTER, NY, 55901-7829, US

(73) Assignee: INTERNATIONAL BUSINESS MACHINES CORPORATION, ARMONK, NY (US)

(21) Appl. No.: 11/097,799

(22) Filed: Apr. 1, 2005

(51) Int. Cl. G06F 3/00

(52) U.S. Cl. 710/8

(57) ABSTRACT

A method, system and article of manufacture for testing data driven software systems and, more particularly, for creating test data configured for testing data driven software systems. One embodiment provides a computer-implemented method of creating test data configured for testing a data driven software system. The method comprises retrieving a configuration schema describing structure and layout of configuration data suitable for driving the software system. The method further comprises retrieving a set of constraints suitable to establish boundaries on possible permutations of the configuration data. The test data is generated on the basis of the configuration schema and the set of constraints.

### BACKGROUND OF THE INVENTION

1. Field of the Invention

The present invention generally relates to data driven software systems and, more particularly, to creating test data configured for testing data driven software systems.

2. Description of the Related Art

The creation of increasingly powerful computer systems and a continuously improved information technology (IT) infrastructure are accompanied by the development of increasingly complex software systems. Recent complex software systems tend to be more and more data driven, i.e., driven by configuration data used to tune and configure runtime behavior of the software systems. Accordingly, such data driven software systems can easily be customized by changing respective entities and attributes of associated configuration data while typical, linear software systems tend to provide a fixed set of functions which can only be customized by writing new code. Thus, more flexible software systems can be designed which can be configured for operation in diverse operational environments, each being described by corresponding configuration data.

A given data driven software system examines its associated configuration data at runtime to determine, on the basis of the respective entities and attributes included therewith, a course of action to take in a given situation. For instance, assume a business application which automatically processes employee travel vouchers for travel reimbursement. This business application must be capable of evaluating a plurality of entities (e.g., employee status, employee travel allocations, expenditure ceilings, approval requirements, etc.) having corresponding attributes. The business application must further be capable of processing or routing requests based on the evaluation of those entities. By way of example, assume that a travel reimbursement for less than $100/day should be automatically accepted and paid if a given employee has a given employee status. A more expensive travel reimbursement should be subjected to a basic approval procedure (e.g., a verification of the employee status, employee travel allocations and expenditure ceilings). Finally, a travel reimbursement for $2500/day and more should be subjected to an advanced approval procedure (e.g., the basic approval procedure as well as a verification of additional requirements, such as approval requirements for the employee, etc.) and might additionally require a manger's approval. In other words, the course of action taken by this business application is conditioned by the received input data and depends on the entities employee status, employee travel allocations, expenditure ceilings, approval requirements, etc., and their corresponding attributes.

One difficulty when dealing with complex data driven software systems is to guarantee that a given data driven software system takes a desired course of action for each possible type of input data. To this end, data driven software systems are subject to elaborate testing procedures in order to verify their runtime behavior. Testing is a key challenge for such software systems given the fact that these systems are expensive to develop and use. However, testing complex data driven software systems is extensive and time-consuming as the runtime behavior of fully-developed systems is somewhat unpredictable and tends to be difficult to model.

One current approach for testing a data driven software system consists in verifying its runtime behavior using suitable test data which models possible input, i.e. possible entities and attributes to the software system. If the software system executes correctly on the suitable test data, an expected result must be obtained. Accordingly, the suitable test data can be determined on the basis of the respective entities and attributes defined by the configuration data associated with an underlying data driven software system. More specifically, since end function and behavior of data driven software systems are driven to a large extent by the respective entities and attributes of the associated configuration data, the configuration data can be considered input data to such software systems. As an exhaustive and comprehensive testing of a given data driven software system needs to include testing of each possible input to the system, including each of a multiplicity of possible variations of configuration data used to tailor the given system is required. However, it can be difficult and time-consuming to manually construct each possible configuration data variation that needs to be supported by and, thus, tested on the given software system.

Therefore, there is a need for an automated technique of creating test data configured for testing data driven software systems.

### SUMMARY OF THE INVENTION

The present invention generally is directed to a method, system and article of manufacture for testing data driven software systems and, more particularly, for creating test data configured for testing data driven software systems.

One embodiment provides a computer-implemented method of creating test data configured for testing a data driven software system. The method comprises retrieving a configuration schema describing structure and layout of configuration data suitable for driving the software system. The method further comprises retrieving a set of constraints suitable to establish boundaries on possible permutations of the configuration data. The test data is generated on the basis of the configuration schema and the set of constraints.

Still another embodiment provides a computer-readable medium containing a program which, when executed by a processor, performs operations for creating test data configured for testing a data driven software system. The operations comprise retrieving a configuration schema describing structure and layout of configuration data suitable for driving the software system. The operations further comprise retrieving a set of constraints suitable to establish boundaries on possible permutations of the configuration data. The test data is generated on the basis of the configuration schema and the set of constraints.

Still another embodiment provides a system for creating test data configured for testing a data driven software system. The system comprises a configuration schema, a set of constraints and a test data generator. The configuration schema describes a structure and layout of configuration data suitable for driving the software system. The set of constraints is suitable to establish boundaries on possible permutations of the configuration data. The test data generator is configured to generate the test data on the basis of the configuration schema and the set of constraints.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with the invention.

FIGS. 2A-2B are relational views of software components in one embodiment.

FIG. 3 is a flow chart illustrating generation of test configuration data in one embodiment.

FIGS. 4A-B are a flow chart illustrating evaluation of configuration schemas in one embodiment.

FIGS. 5A-B are a flow chart illustrating processing configuration item constraints in one embodiment.

FIGS. 6A-B are a flow chart illustrating generation of a test configuration data output structure in one embodiment.

### DETAILED DESCRIPTION OF THE PREFERRED EMBODIMENTS

Introduction

The present invention generally is directed to a method, system and article of manufacture for testing data driven software systems and, more particularly, for creating test data configured for testing data driven software systems. A data driven software system is a software system that is driven by configuration data used to tune and configure runtime behavior of the software system. Accordingly, a data driven software system examines its associated configuration data at runtime to determine a course of action to take in a given situation.

In one embodiment, test data configured for testing a data driven software system is generated. According to one aspect, the test data includes test input data and test configuration data. The test input data models different types of input data to the software system. The test configuration data models different types of configuration data for the software system.

According to one aspect, the test input data can be created on the basis of existing exemplary input data which can be retrieved from memory. For instance, in the given example above of the business application, previously processed travel vouchers for travel reimbursement and suitable variations thereof can be used as test input data. According to another aspect, the test input data is generated based on an input data schema and corresponding input data constraints. The input data schema describes input data that is suitable as input to the data driven software system. The input data constraints are suitable to establish boundaries on possible permutations of the test input data.

In one embodiment, the test configuration data is generated based on a configuration schema and a set of constraints. The configuration schema is associated with the data driven software system and describes configuration data that is suitable for driving the software system. According to one aspect, the configuration schema includes a plurality of configuration items that describe the structure and layout of the suitable configuration data. The set of constraints is suitable to establish boundaries on possible permutations of the test configuration data. More specifically, the set of constraints defines constraints for one or more of the configuration items of the configuration schema. Thus, the test configuration data can be generated using the configuration items and the constraints which are defined for the configuration items.

### Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

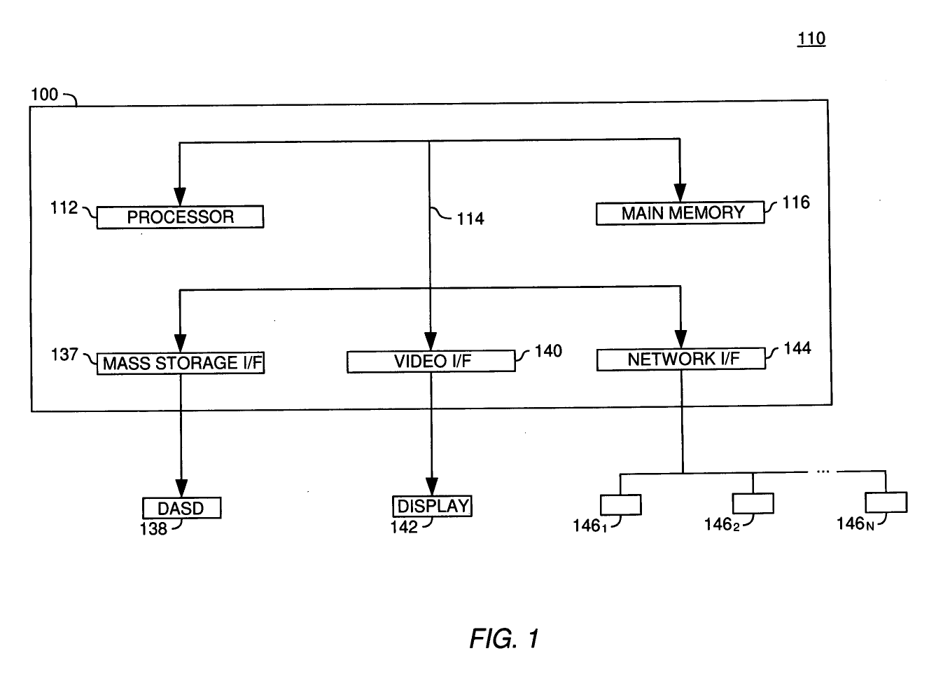

One embodiment of the invention is implemented as a program product for use with a computer system such as, for example, computer system 110 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Computing Environment

FIG. 1 shows a computer 100 (which is part of a computer system 110) that becomes a special-purpose computer according to an embodiment of the invention when configured with the features and functionality described herein. The computer 100 may represent any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention. Illustratively, the computer 100 is part of a networked system 110. In this regard, the invention may be practiced in a distributed computing environment in which tasks are performed by remote processing devices that are linked through a communications network. In a distributed computing environment, program modules may be located in both local and remote memory storage devices. In another embodiment, the computer 100 is a standalone device. For purposes of construing the claims, the term “computer” shall mean any computerized device having at least one processor. The computer may be a standalone device or part of a network in which case the computer may be coupled by communication means (e.g., a local area network or a wide area network) to another device (i.e., another computer).

In any case, it is understood that FIG. 1 is merely one configuration for a computer system. Embodiments of the invention can apply to any comparable configuration, regardless of whether the computer 100 is a complicated multi-user apparatus, a single-user workstation, or a network appliance that does not have non-volatile storage of its own.

The computer 100 could include a number of operators and peripheral systems as shown, for example, by a mass storage interface 137 operably connected to a storage device 138, by a video interface 140 operably connected to a display 142, and by a network interface 144 operably connected to the plurality of networked devices 146 (which may be representative of the Internet) via a suitable network 148. Although storage 138 is shown as a single unit, it could be any combination of fixed and/or removable storage devices, such as fixed disc drives, floppy disc drives, tape drives, removable memory cards, or optical storage. The display 142 may be any video output device for outputting viewable information.

Computer 100 is shown comprising at least one processor 112, which obtains instructions and data via a bus 114 from a main memory 116. The processor 112 could be any processor adapted to support the methods of the invention. In particular, the computer processor 112 is selected to support the features of the present invention. Illustratively, the processor is a PowerPC® processor available from International Business Machines Corporation of Armonk, N.Y.

The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in the computer system 110, for example, any storage capacity used as virtual memory or stored on a mass storage device (e.g., direct access storage device 138) or on another computer coupled to the computer 100 via bus 114. Thus, main memory 118 and storage device 134 could be part of one virtual address space spanning multiple primary and secondary storage devices.

### An Exemplary Software System Runtime Environment

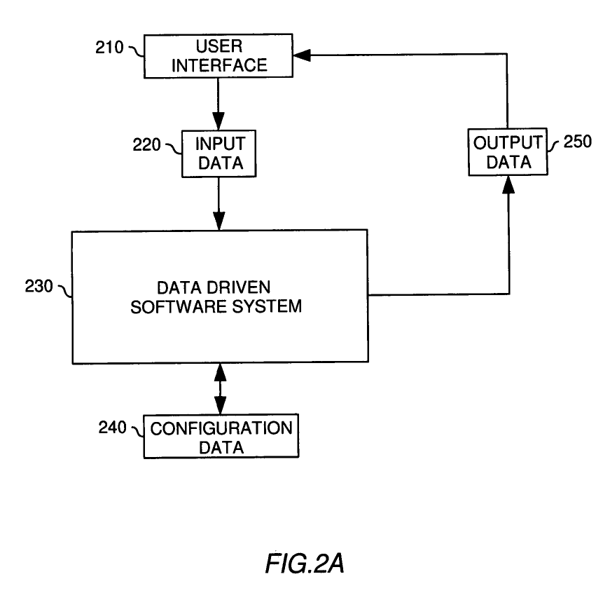

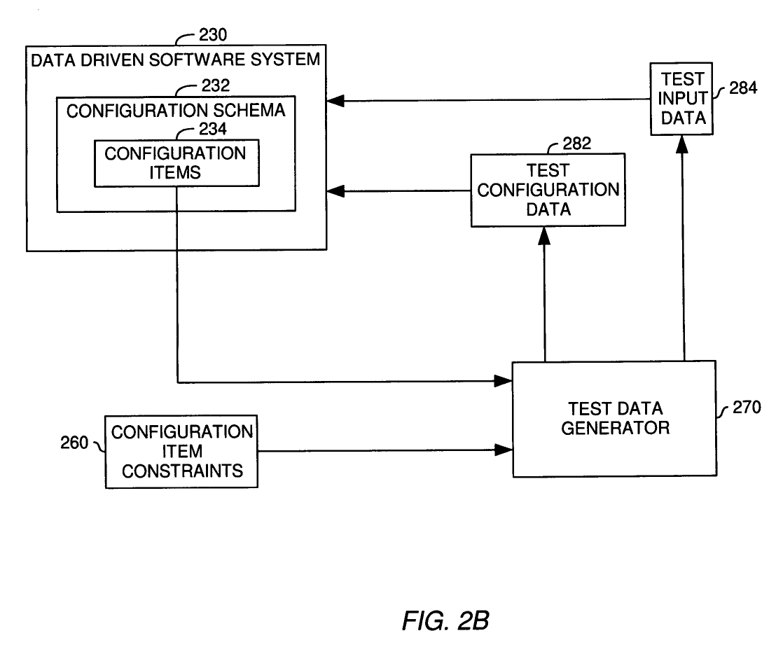

Referring now to FIG. 2A, a relational view of components illustrating operation of a data driven software system in one embodiment is shown. Illustratively, the components include a user interface 210, a data driven software system 230 and associated configuration data 240.

The user interface 210 allows users to create input data 220 and to submit the created input data 220 to the data driven software system 230 for processing. Accordingly, the user interface 210 can be any suitable user interface configured to create/submit the input data 220. In one embodiment, the user interface 210 is a graphical user interface that displays a multiplicity of graphical selection/input elements for creation and submission of the input data 220. However, it should be noted that the user interface 210 is only shown by way of example. In other words, any suitable requesting entity may provide the input data 220 to the data driven software system 230 (e.g., an application, the operating system or an end user). Accordingly, all such implementations are broadly contemplated.

In one embodiment, the input data 220 is in a format that is suitable for the data driven software system 230. The data driven software system 230 receives the input data 220 and examines the associated configuration data 240. According to one aspect, the configuration data 240 defines a set of rules, each defining a given action to take with respect to a possible type of input data. Each rule may further define one or more conditions which must be satisfied before the given action is invoked. Thus, the data driven software system 230 can determine a course of action to take with respect to the input data 220 on the basis of the configuration data 240. According to the determined course of action, the data driven software system 230 processes the input data 220 and produces corresponding output data 250. The output data 250 is returned to the user interface 210.

For purposes of illustration, an exemplary operation of the data driven software system 230 is described in more detail with reference to the above described business application example. In the given example, the input data 220 defines an expense account which is created on the basis of an employee travel voucher. The data driven software system 230 is the business application which automatically processes expense accounts for travel reimbursement. An exemplary expense account corresponding to the input data 220 is shown in Table I below. By way of illustration, the exemplary expense account is defined using XML. However, any other language may be used to advantage. Furthermore, it should be noted that in the following only components of the exemplary expense account of Table I which are required for a complete understanding of embodiments of the invention are described in more detail where required, for brevity.

TABLE I
EXPENSE ACCOUNT EXAMPLE

```
001  <?xml version=“1.0” encoding=“UTF-8” ?>
002  − <e:ExpenseAccount empld=“1111” empName=“Smith, John”
003  xmlns:e=“http://www.mycompany.com”
004  xmlns:xsi=“http://www.w3.org/2001/XMLSchema-instance”
005  xsi:schemaLocation=“http://www.mycompany.com
006  ExpenseAccount.xsd”empStatus=“regular”>
007  <ExpenseItem amount=“99.00” date=“2001-01-01”
      type=“hotel” />
008  <ExpenseItem amount=“2.50” date=“2001-01-01”
      type=“telephone” />
009  </e:ExpenseAccount>
```

Illustratively, the expense account shown in Table I includes a plurality of account-related elements (lines 002 and 006-008) used to provide information with respect to expenses of a given employee. More specifically, the exemplary expense account of Table I has been created for an employee “Smith, John” (“empName” in line 002). The user “Smith, John” is a regular employee (“empStatus” in line 006) and is uniquely identified by a unique employee identifier “1111” (“empID” in line 002). Furthermore, the user “Smith, John” has paid: (i) an amount of $99.00 (“amount” in line 007) for a hotel (“type” in line 007) on Jan. 1 st, 2001 (“date” in line 007), and (ii) an amount of $2.50 (“amount” in line 008) for a phone call (“type” in line 008) on Jan. 1st, 2001 (“date” in line 008).

In the given example, the exemplary expense account of Table I is an instance (“XMLSchema-instance” in line 004 of Table I) of an underlying expense account schema. More specifically, the exemplary expense account of Table I is an instance of an underlying “ExpenseAccount.xsd” XML schema (line 005 of Table I). An exemplary expense account schema corresponding to the “ExpenseAccount.xsd” XML schema is shown in Table II below. However, it should be noted that in the following only components of the exemplary expense account schema of Table II which are required for a complete understanding of embodiments of the invention are described in more detail where required, for brevity.

TABLE II
EXPENSE ACCOUNT SCHEMA EXAMPLE

001 <?xml version=“1.0” encoding=“UTF-8”?>
002 <schema xmlns=“http://www.w3.org/2001/XMLSchema”
003 targetNamespace=“http://www.mycompany.com”
004 xmlns:ExpenseAccount=“http://www.mycompany.com”>
005 <element name=“ExpenseAccount”>
006 <complexType>
007 <sequence>
008 <element name=“ExpenseItem” minOccurs=“1”
009 maxOccurs=“unbounded”>
010 <complexType>
011 <attribute name=“date” type=“date” use=“required”></attribute>
012 <attribute name=“type” use=“required”>
013 <simpleType>
014 <restriction base=“string”>
015 <enumeration value=“air”></enumeration>
016 <enumeration value=“food”></enumeration>
017 <enumeration value=“hotel”></enumeration>
018 <enumeration value=“car”></enumeration>
019 <enumeration value=“telephone”></enumeration>
020 <enumeration value=“misc”></enumeration>
021 </restriction>
022 </simpleType>
023 </attribute>
024 <attribute name=“amount” type=“decimal” use=“required”></attribute>
025 </complexType>
026 </element>
027 </sequence>
028 <attribute name=“empName” type=“string” use=“required”></attribute>
029 <attribute name=“empStatus” use=“required”>
030 <simpleType>
031 <restriction base=“string”>
032 <enumeration value=“regular”></enumeration>
033 <enumeration value=“executive”></enumeration>
034 <enumeration value=“retiree”></enumeration>
035 <enumeration value=“onleave”></enumeration>
036 </restriction>
037 </simpleType>
038 </attribute>
039 <attribute name=“empld” type=“string” use=“required”></attribute>
040 </complexType>
041 </element>
042 </schema>

As can be seen from the exemplary expense account schema of Table II, the account-related elements “empName”, “empstatus” and “emplD” of Table I are defined in lines 028, 029 and 039, respectively. The account-related elements “date”, “type” and “amount” of Table I are defined in lines 011, 012 and 024, respectively. Furthermore, the “empStatus” (line 029) is associated with a list of allowed employee status values (lines 032-035). Accordingly, the employee status of a given employee may only be one of (i) “regular”, (ii) “executive”, (iii) “retiree”, and (iv) “onleave”. Moreover, the “type” of expense (line 012) is also associated with a list of allowed values (lines 015-020). Accordingly, the expense type of a given expense may only be one of (i) “air”, (ii) “food”, (iii) “hotel”, (iv) “car”, (v) “telephone”, and (vi) “misc”.

In the given example, the business application (i.e., the data driven software system 230) receives the exemplary expense account of Table I (i.e., input data 220) and examines associated business application configuration data (i.e., configuration data 240) to determine which action needs to be performed with respect to the received expense account. Illustrative business application configuration data corresponding to the configuration data 240 is shown in Table III below. By way of illustration, the illustrative business application configuration data is defined using XML. However, any other language may be used to advantage. Furthermore, it should be noted that in the following only components of the illustrative business application configuration data of Table III which are required for a complete understanding of embodiments of the invention are described in more detail where required, for brevity.

TABLE III
BUSINESS APPLICATION CONFIGURATION DATA EXAMPLE

001 <?xml version=“1.0” encoding=“UTF-8” ?>
002 − <e:ExpenseProcess xmlns:e=“http://www.mycompany.com”
003 xmlns:xsi=“http://www.w3.org/2001/XMLSchema-instance”
004 xsi:schemaLocation=“http://www.mycompany.com ExpenseProcess.xsd”>
005 − <ExpenseRule>
006 − <Condition operator=“AND”>
007 <Condition operator=“LT” attribute=“totAmount” value=“100” />
008 <Condition operator=“EQ” attribute=“empStatus” value=“regular” />
009 </Condition>
010 <Action type=“approve” />
011 </ExpenseRule>
012 − <ExpenseRule>
013 − <Condition operator=“AND”>
014 <Condition operator=“GE” attribute=“totAmount” value=“100” />
015 <Condition operator=“LT” attribute=“totAmount” value=“2500” />
016 <Condition operator=“EQ” attribute=“empStatus” value=“regular” />
017 </Condition>
018 − <Action type=“review”>
019 <Reviewer name=“Fred Smith”
020 emailAddress=“fsmith@mycompany.com” />
021 </Action>
022 </ExpenseRule>
023 − <ExpenseRule>
024 − <Condition operator=“AND”>
025 <Condition operator=“GE” attribute=“totAmount” value=“2500” />
026 <Condition operator=“NE” attribute=“empStatus” value=“executive”
/>
027 </Condition>
028 − <Action type=“review”>
029 <Reviewer name=“Fred Smith”
030 emailAddress=“fsmith@mycompany.com” />
031 </Action>
032 − <Action type=“review”>
033 <Reviewer name=“Bill Penny”
034 emailAddress=“controller@mycompany.com” />
035 </Action>
036 </ExpenseRule>
037 </e:ExpenseProcess>

Illustratively, the exemplary business application configuration data shown in Table III defines three rules, each indicating an action to be performed dependent on whether an associated condition(s) is satisfied. In the illustrated example, a first rule (lines 005-011) defines that a received expense account should be approved (“approve” in line 010) if the total amount of the received expense account is less than $100 (“totAmount”, “LT” and “100” in line 007) and if the employee status of the employee who has paid the amount is regular (“empStatus”, “EQ” and “regular” in line 008). A second rule (lines 012-022) defines that a received expense account should be reviewed (“review” in line 018) by a single reviewer if the total amount of the received expense account is greater or equal than $100 (“totAmount”, “GE” and “100” in line 014) and less than $2,500 (“totAmount”, “LT” and “2500” in line 015), and if the employee status of the employee who has paid the amount is regular (“empStatus”, “EQ” and “regular” in line 016). The reviewer is “Fred Smith” who has the e-mail address “fsmith@mycompany.com” (lines 019-020). A third rule (lines 023-036) defines that a received expense account should be reviewed (“review” in line 028 and 032) by two reviewers if the total amount of the received expense account is greater or equal than $2,500 (“totAmount”, “GE” and “2500” in line 025), and if the employee status of the employee who has paid the amount is not executive (“empStatus”, “NE” and “executive” in line 026). In this case the reviewers are “Fred Smith” with the e-mail address “fsmith@mycompany.com” (lines 029-030) and “Bill Penny” with the e-mail address controller@mycompany.com (lines 033-034).

In one embodiment, the exemplary business application configuration data of Table III is an instance (“XMLSchema-instance” in line 003 of Table II) of an underlying business application configuration schema “ExpenseProcess.xsd” (line 004 of Table II). The underlying business application configuration schema defines configurations items which can be used to specify an action and corresponding condition(s) for each of the rules included with the exemplary business application configuration data. An exemplary business application configuration schema corresponding to the “ExpenseProcess.xsd” schema is illustrated in Table IV, which is described in more detail with reference to FIG. 2B.

As was noted above, in the given example the employee “Smith, John” has the employee status “regular” (line 006 of Table I). Furthermore, the expenses of the employee “Smith, John” are of a total amount of $101.50 ($99+$2.50 according to lines 007-008 of Table I). As the employee status of “Smith, John” is regular and as the total amount is greater than $100 and less than $2,500, the underlying business application, applies the second rule according to lines 012-022 of the exemplary business application configuration data of Table III to the exemplary expense account of Table I. Accordingly, in the given example the underlying business application returns a notification (i.e., the output data 250) indicating that the received expense account of Table I should be transmitted to “Fred Smith” for review.

### An Exemplary Test Data Generation Environment

Referring now to FIG. 2B, a relational view of components illustrating generation of test data for a data driven software system in one embodiment is shown. Illustratively, the components include the data driven software system 230 of FIG. 2A, configuration item constraints 260 and a test data generator 270. The test data generator 270 is configured to generate the test data for testing the data driven software system 230. Illustratively, the test data consists of test configuration data 282 and test input data 284.

According to FIG. 2B, the data driven software system 230 includes an associated configuration schema 232. The configuration schema 232 is shown included with the data driven software system 230 by way of example. However, it should be noted that in various embodiments the configuration schema 232 is provided separate from the data driven software system 230. Furthermore, the configuration schema 232 can be stored in any suitable storage independent of the data driven software system 230, which can be local or remote with respect to the storage used for storing the data driven software system 230. Moreover, in FIG. 2B only a single configuration schema 232 is shown for simplicity. However, according to embodiments of the invention the data driven software system 230 can be associated with a plurality of configuration schemas which can be defined in any suitable format, including XML. Accordingly, all such implementations are broadly contemplated.

In general, the configuration schema 232 describes structure and layout of any configuration data (e.g., configuration data 240 of FIG. 2A) suitable for driving the data driven software system 230. Illustratively, the configuration schema 232 defines a plurality of configuration items 234. Each configuration item is configured to control or drive some behavior of the data driven software system 230. In the illustrated embodiment of FIGS. 2A-B, the structure and layout of the configuration data 240 of FIG. 2A is described using at least a portion of the plurality of configuration items 234 of FIG. 2B.

In the given example, the configuration schema 232 defines a business application configuration schema that is associated with the business application which automatically processes expense accounts for travel reimbursement. An Illustrative business application configuration schema corresponding to the configuration schema 232 is shown in Table IV below. Accordingly, the illustrative business application configuration schema of Table IV defines structure and layout of the exemplary business application configuration data of Table III above. By way of illustration, the exemplary business application configuration schema is defined using XML. However, any other language may be used to advantage. Furthermore, it should be noted that in the following only components of the exemplary business application configuration schema of Table IV which are required for a complete understanding of embodiments of the invention are described in more detail where required, for brevity.

TABLE IV
BUSINESS APPLICATION CONFIGURATION SCHEMA EXAMPLE

001 <?xml version=“1.0” encoding=“UTF-8”?>
002 <schema xmlns=“http://www.w3.org/2001/XMLSchema”
003 targetNamespace=“http://www.mycompany.com”
004 xmlns:ExpenseProcess=“http://www.mycompany.com”>
005 <element name=“ExpenseProcess”>
006 <complexType>
007 <sequence>
008 <element name=“ExpenseRule” minOccurs=“1”
009 maxOccurs=“unbounded”>
010 <complexType>
011 <sequence>
012 <element name=“Condition”
013 type=“ExpenseProcess:ConditionType” minOccurs=“0”
014 maxOccurs=“unbounded”></element>
015 <element name=“Action” minOccurs=“1”
016 maxOccurs=“unbounded”>
017 <complexType>
018 <sequence>
019 <element name=“Reviewer” minOccurs=“0”
020 maxOccurs=“unbounded”>
021 <complexType>
022 <attribute name=“name” type=“string”
023 use=“required”></attribute>
024 <attribute name=“emailAddress” type=“string”
025 use=“required”></attribute>
026 </complexType>
027 </element>
028 </sequence>
029 <attribute name=“type” use=“required”>
030 <simpleType>
031 <restriction base=“string”>
032 <enumeration value=“approve”></enumeration>
033 <enumeration value=“review”></enumeration>
034 <enumeration value=“reject”></enumeration>
035 </restriction>
036 </simpleType>
037 </attribute>
038 </complexType>
039 </element>
040 </sequence>
041 </complexType>
042 </element>
043 </sequence>
044 </complexType>
045 </element>
046
047 <complexType name=“ConditionType”>
048 <sequence>
049 <element name=“Condition” type=“ExpenseProcess:ConditionType”
050 minOccurs=“0” maxOccurs=“unbounded”></element>
051 </sequence>
052 <attribute name=“attribute” type=“string” use=“optional”></attribute>
053 <attribute name=“operator” use=“required”>
054 <simpleType>
055 <restriction base=“string”>
056 <enumeration value=“EQ”></enumeration>
057 <enumeration value=“NE”></enumeration>
058 <enumeration value=“GT”></enumeration>
059 <enumeration value=“LT”></enumeration>
060 <enumeration value=“GE”></enumeration>
061 <enumeration value=“LE”></enumeration>
062 <enumeration value=“EXISTS”></enumeration>
063 <enumeration value=“OR”></enumeration>
064 <enumeration value=“AND”></enumeration>
065 </restriction>
066 </simpleType>
067 </attribute>
068 <attribute name=“value” type=“string” use=“optional”></attribute>
069 <attribute name=“negated” type=“boolean” use=“optional”></attribute>
070 </complexType>
071
072 </schema>

According to lines 005-045, the exemplary business application configuration schema of Table IV generically specifies rules for configuration data that is suitable for the underlying business application (e.g., the rules of the business application configuration data of Table III). Specifically, a minimum and maximum number of required/allowed rules are defined in lines 008-009. According to line 008, at least one rule must be included with any configuration data that is defined using the exemplary business application configuration schema of Table IV (minOccurs=“1” in line 008) and an unlimited maximum number of rules is allowed (maxOccurs=“unbounded” in line 009). According to lines 012-014, each rule may include an unlimited number of conditions (minOccurs=“0” in line 013 and maxOccurs=“unbounded” in line 014). Structure and layout of the condition(s) are generically defined in lines 047-070, as described below by way of example. Furthermore, according to lines 015-039 each rule must define at least one action to be performed (minOccurs=“1” in line 015 and maxOccurs=“unbounded” in line 016). Structure and layout of actions are generically defined in lines 017-038.

For purposes of illustration, construction of the condition “<Condition operator=“LT” attribute=“totAmount” value=“100”/>” of the exemplary business application configuration data of Table III (line 007) is now described in more detail. The keyword “Condition” is defined on the basis of line 049 of Table IV. The configuration item “operator” is defined on the basis of line 053 and has the value “LT” on the basis of line 059. The configuration item “attribute” is defined on the basis of line 052 and has the value “totAmount”. The configuration item “value” is defined on the basis of line 068 and has the value “100”. In other words, each element, attribute and/or value of the exemplary business application configuration schema of Table IV which is used to define a condition and/or action in a given rule represents a configuration item which may have an associated value. The associated value can be defined by the exemplary business application configuration schema of Table IV (e.g., “LT” for the configuration item “operator”).

Using the plurality of configuration items 234, various configuration data can be created for the data driven software system 230. By way of example, rules can be added to and/or removed from existing configuration data in order to create different configuration data. Furthermore, one or more rules of the existing configuration data can be modified to obtain different configuration data. Specifically, the configuration data can be adapted such that a required behavior of the data driven software system 230 can be achieved. For instance, as was noted above with reference to Table III, in the given example a first rule defines two conditions using the configuration items “attribute”, “operator” and “value” (lines 007-008 of Table III) and an action to be performed if the conditions are satisfied using the configuration item “type” (line 010 of Table III). In the first condition according to line 007 of Table III, the configuration item “attribute” has the value “totAmount”, the configuration item “operator” has the value “LT”, and the configuration item “value” has the value “100”. In the second condition according to line 008 of Table III, the configuration item “attribute” has the value “empStatus”, the configuration item “operator” has the value “EQ”, and the configuration item “value” has the value “regular”. According to line 010 of Table III, the action is defined by associating the value “approve” with the configuration item “type”. Assume now that in the first condition the value “100” of the configuration item “value” is replaced with a value “10” and that the second condition is removed from the first rule. Accordingly, only expense accounts would be approved where the total amount of the received expense account is less than $10 independent of the employee status of the employee who has paid the amount. Another example is creation of a new rule which may define that a received expense account should be approved if the total amount of the received expense account is less than $10,000 and if the employee status of the employee who has paid the amount is executive.

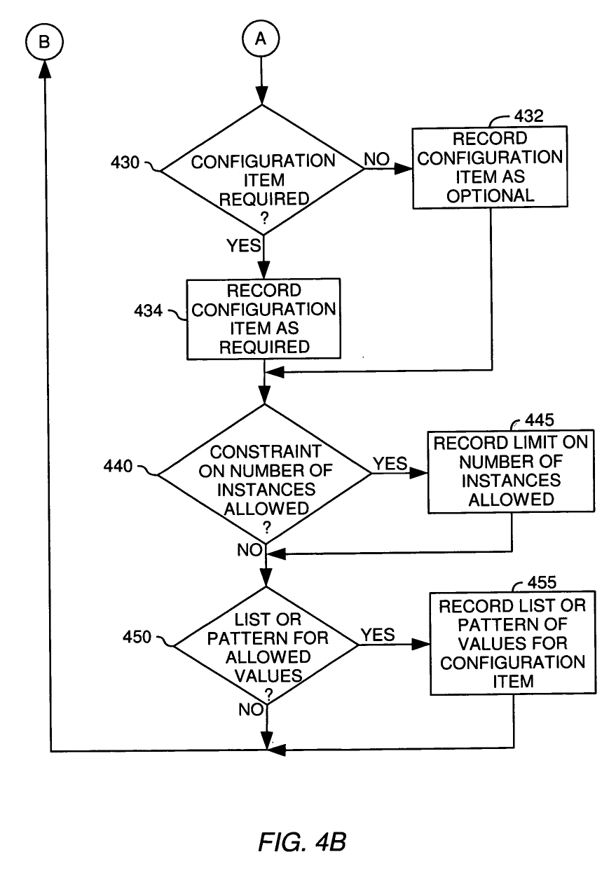

In one embodiment, the test data generator 270 evaluates the configuration schema 232 in order to identify the configuration items 234 therefrom. An exemplary method for evaluation of a configuration schema is described below with reference to FIGS. 4A-B. The test data generator 270 further retrieves the configuration item constraints 260. The configuration item constraints 260 define constraints which are suitable to establish boundaries on possible permutations of the test configuration data 282. In the given example, the configuration item constraints 260 define business application constraints which are suitable to establish boundaries on possible permutations of test configuration data that is suitable for testing the business application. Illustrative business application constraints corresponding to the configuration item constraints 260 are shown in Table V below. By way of illustration, the illustrative business application constraints are defined using XML. However, any other language may be used to advantage. Furthermore, it should be noted that in the following only components of the illustrative business application constraints of Table V which are required for a complete understanding of embodiments of the invention are described in more detail where required, for brevity.

TABLE V
BUSINESS APPLICATION CONSTRAINTS EXAMPLE

001 <?xml version=“1.0” encoding=“UTF-8” ?>
002 − <t:TestDataConstraint xmlns:t=“http://www.mycompany.com”
003 xmlns:xsi=“http://www.w3.org/2001/XMLSchema-instance”
004 xsi:schemaLocation=“http://www.mycompany.com TestDataConstraint.xsd”>
005 − <Schema location=“.” name=“ExpenseProcess.xsd” type=“XML”
006 processOrder=“1”>
007 − <Item locator=“/ExpenseRule/Condition/@operator” significant=“true”>
008 − <ValueListConstraint>
009 <Value val=“EQ” />
010 <Value val=“GT” />
011 </ValueListConstraint>
012 </Item>
013 − <Item locator=“/ExpenseRule/Condition/@attribute” significant=“true”>
014 − <ValueListConstraint>
015 <Value val=“totAmount” />
016 </ValueListConstraint>
017 </Item>
018 − <Item locator=“/ExpenseRule/Action/@type” significant=“true”>
019 − <ValueListConstraint>
020 <Value val=“review” />
021 </ValueListConstraint>
022 </Item>
023 − <Item locator=“/ExpenseRule/Action/Reviewer” significant=“true”>
024 <CardinalityConstraint max=“2” min=“0” />
025 </Item>
026 </Schema>
027 </t:TestDataConstraint>

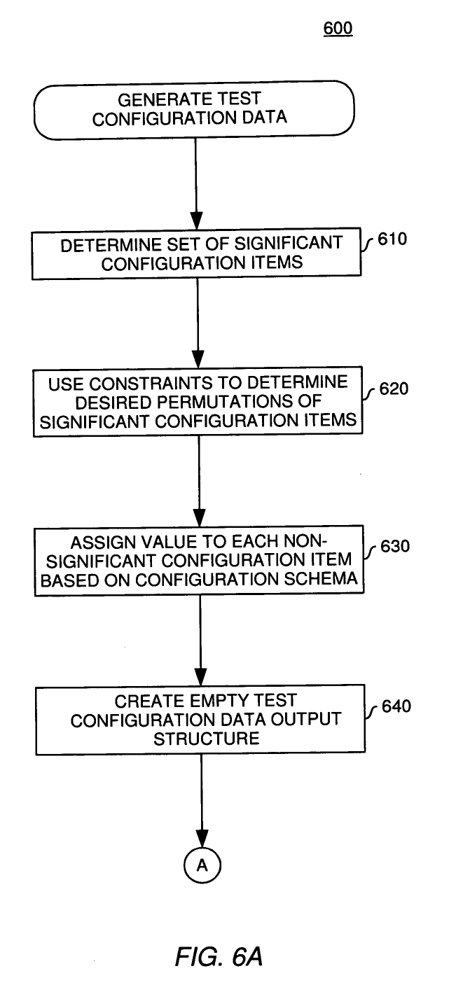

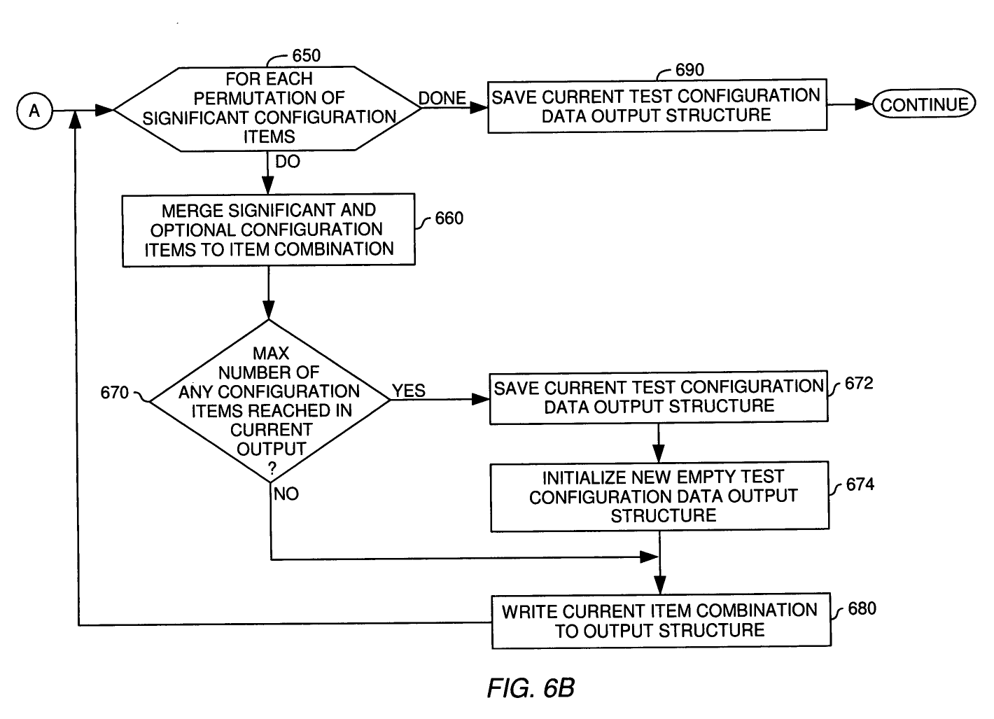

Illustratively, the exemplary business application constraints shown in Table V define constraints on the configuration items “operator” (lines 007-012), “attribute” (lines 013-017), “type” (lines 018-022), and “Reviewer” (lines 023-025). The defined constraints are described in more detail below. Each of the configuration items is determined to be a significant item (significant=“true” in lines 007, 013, 018 and 023). A significant configuration item is a configuration item which affects runtime behavior of the data driven software system 230. Accordingly, a variation of the value of a significant configuration item may result in a completely different behavior of the data driven software system 230. Thus, in one embodiment generation of the test configuration data 282 by the test data generator 270 focuses on significant configuration items ensuring that these significant configuration items and all possible values for these significant configuration items are included in the test configuration data 282 relative to the constraints defined in Table V. Configuration items that are not determined to be significant are also represented in the generated test configuration data 282, but will not have an exhaustive set of possible values generated, as described in more detail below with reference to FIGS. 6A-B. The exemplary business application constraints of Table V further include an indication of the underlying configuration schema used to generate the test configuration data 282. By way of example, the exemplary business application constraints of Table V include an indication of a storage location where the business application configuration schema of Table IV is stored (lines 005-006).

In one embodiment, the exemplary business application constraints of Table V are an instance (“XMLSchema-instance” in line 003 of Table V) of an underlying business application constraints schema “TestDataConstraint.xsd” (line 004 of Table V). The underlying business application constraints schema generically defines constraints which can be used to specify the exemplary business application constraints of Table V. An exemplary business application constraints schema corresponding to the “TestDataConstraint.xsd” schema is illustrated in Table VI below. By way of illustration, the illustrative business application constraints schema is defined using XML. However, any other language may be used to advantage. Furthermore, it should be noted that in the following only components of the illustrative business application constraints schema of Table VI which are required for a complete understanding of embodiments of the invention are described in more detail where required, for brevity.

TABLE VI
CONFIGURATION ITEM CONSTRAINTS SCHEMA EXAMPLE

001 <?xml version=“1.0” encoding=“UTF-8”?>
002 <schema xmlns=“http://www.w3.org/2001/XMLSchema”
003 targetNamespace=“http://www.mycompany.com”
004 xmlns:TestDataConstraint=“http://www.mycompany.com”>
005 <element name=“TestDataConstraint”>
006 <complexType>
007 <sequence>
008 <element name=“Schema” minOccurs=“1” maxOccurs=“unbounded”>
009 <complexType>
010 <sequence>
011 <element name=“Item” minOccurs=“1” maxOccurs=“unbounded”>
012 <complexType>
013 <choice minOccurs=“1” maxOccurs=“unbounded”>
014 <element name=“ValueListConstraint”>
015 <complexType>
016 <sequence>
017 <element name=“Value” minOccurs=“1”
018 maxOccurs=“unbounded”>
019 <complexType>
020 <attribute name=“val” type=“string”
021 use=“required”></attribute>
022 </complexType>
023 </element>
024 </sequence>
025 </complexType>
026 </element>
027 <element name=“ValueRangeConstraint”>
028 <complexType>
029 <attribute name=“min” type=“string”
030 use=“optional”></attribute>
031 <attribute name=“max” type=“string”
032 use=“optional”></attribute>
033 </complexType>
034 </element>
035 <element name=“RecursionConstraint”>
036 <complexType>
037 <attribute name=“depth” type=“positiveInteger”
038 use=“required”></attribute>
039 </complexType>
040 </element>
041 <element name=“CoexistConstraint”>
042 <complexType>
043 <attribute name=“schemaRef” type=“string”
044 use=“required”></attribute>
045 <attribute name=“locator” type=“string”
046 use=“required”></attribute>
047 </complexType>
048 </element>
049 <element name=“CardinalityConstraint”>
050 <complexType>
051 <attribute name=“min” type=“integer”
052 use=“required”></attribute>
053 <attribute name=“max” type=“integer”
054 use=“required”></attribute>
055 </complexType>
056 </element>
057 </choice>
058 <attribute name=“significant” type=“boolean”
059 use=“required”></attribute>
060 <attribute name=“locator” type=“string”
061 use=“required”></attribute>
062 </complexType>
063 </element>
064 </sequence>
065 <attribute name=“name” type=“string” use=“required”></attribute>
066 <attribute name=“location” type=“string” use=“required”></attribute>
067 <attribute name=“type” use=“required”>
068 <simpleType>
069 <restriction base=“string”>
070 <enumeration value=“XML”></enumeration>
071 <enumeration value=“relational”></enumeration>
072 <enumeration value=“other”></enumeration>
073 </restriction>
074 </simpleType>
075 </attribute>
076 <attribute name=“processOrder” type=“positiveInteger”
077 use=“required”></attribute>
078 </complexType>
079 </element>
080 </sequence>
081 </complexType>
082 </element>
083 </schema>

Illustratively, the exemplary business application constraints schema of Table VI defines elements (lines 065-077) which can be used to create an identification of the underlying configuration schema used to generate the test configuration data 282. The exemplary business application constraints schema of Table VI further defines a significant element identifier (“significant” in lines 058-059) and a location identifier (“locator” in lines 060-061). The significant element identifier can be used to mark a given configuration item as significant, as was noted above with reference to Table V. The location identifier can be used to identify a location of a given configuration item. Furthermore, the exemplary business application constraints schema shown in Table VI defines five constraints: (i) a value list constraint (“ValueListConstraint” in lines 014-026), (ii) a value range constraint (“ValueRangeConstraint” in lines 027-034), (iii) a depth of recursion constraint (“RecursionConstraint” in lines 035-040), (iv) a coexistence constraint (“CoexistConstraint” in lines 041-048), and (v) a cardinality constraint (“CardinalityConstraint” in lines 049-056), which are described in more detail below.

In one embodiment, the value list constraint can be used to identify possible values for a given configuration item. Accordingly, the value list constraint is also referred to hereinafter as a “possible value constraint”. The test data generator 270 uses such possible value constraints to select values for configuration items used in the test configuration data 282. As was noted above, in some cases the possible values for a given configuration item can be extracted from the underlying configuration schema 232. The value range constraint can be used to identify ranges of values for a given configuration item. In some cases, natural boundaries exist in a range of values supported for certain configuration items, such as less than 0, 0 or greater than 0. These boundaries can be identified for generation of the test configuration data 282 using a value range constraint. In this case, the value range constraint can also be referred to as a “boundary identifier constraint”. The depth of recursion constraint can be used in cases where the configuration schema 232 defines a recursive data structure and is configured to control how deep to recurse in the generated test configuration data 282. The coexistence constraint is configured to specify that the presence of one configuration item within the generated test configuration data 282 must be accompanied by another specified configuration item. Coexistence constraints can be defined for two configuration items within a single configuration schema or for configuration items of different configuration schemas. The cardinality constraint establishes an upper bound on the number of instances of a given configuration item in the generated test configuration data 282. In some cases, the underlying configuration schema may place no bounds on the number of instances of the given configuration item that may appear within a valid instance of the configuration schema, i.e., the test configuration data 282. In these cases, the upper bound can be defined using a cardinality constraint.

It should be noted that the above described constraints are merely described by way of example. However, the present invention is not limited to the described types of constraints and various other configuration item constraints can be provided. For instance, a value equivalency constraint can be specified which is configured to define a relationship between individual values assigned to different configuration items occurring in the test configuration data 282. More specifically, a value equivalency constraint may indicate that a first configuration item in the test configuration data 282 must be accompanied by a second configuration item, where the value of the first configuration item must be a function of the value of the second configuration item. Accordingly, any suitable configuration item constraint is broadly contemplated.

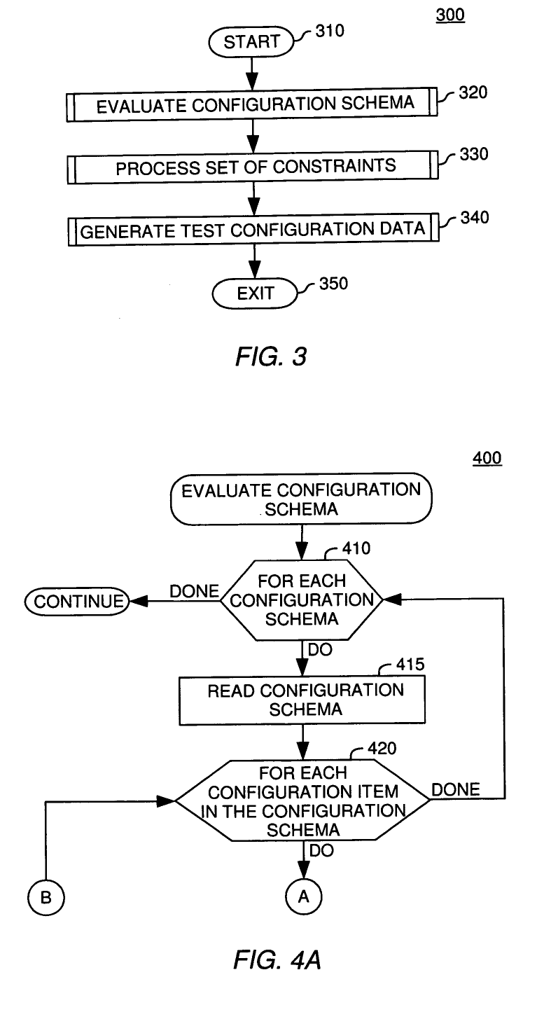

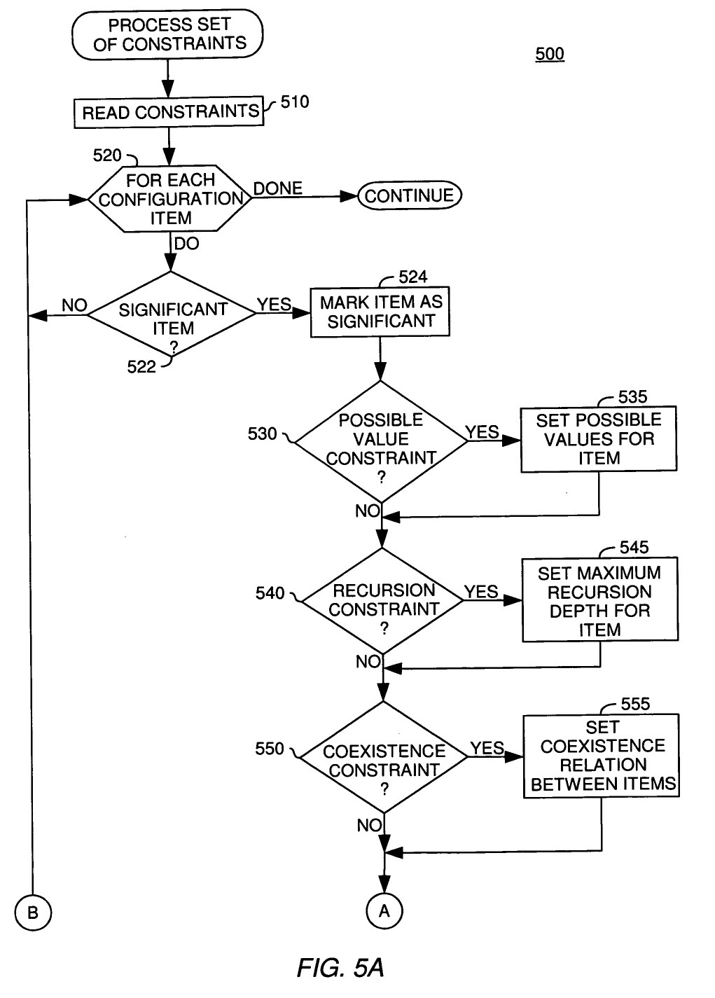

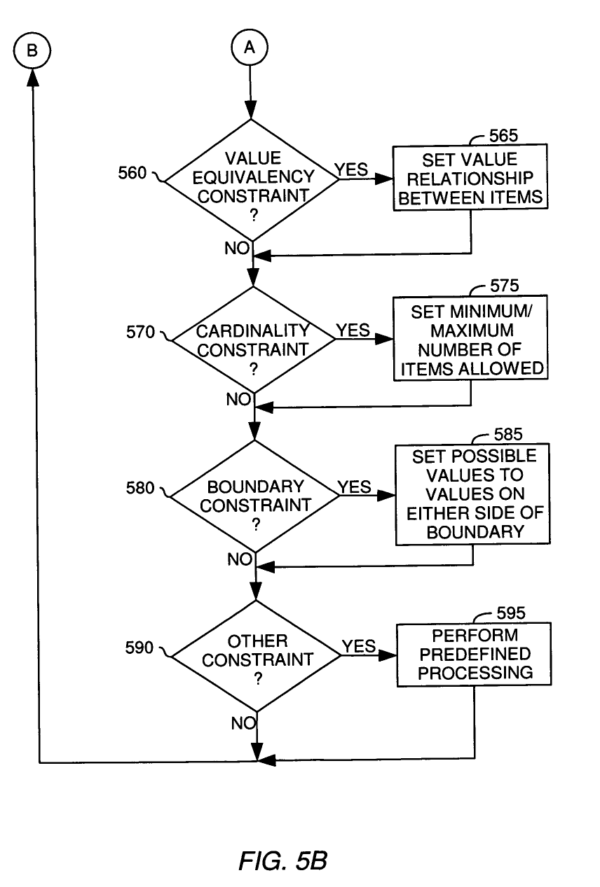

In one embodiment, the test data generator 270 evaluates the configuration item constraints 260. An exemplary method for evaluating configuration item constraints is described below with reference to FIGS. 5A-B. On the basis of the evaluated configuration item constraints 260 and the identified configuration items 234, the test data generator 270 generates the test configuration data 282 and test input data 284. The test input data 284 can be created on the basis of existing exemplary input data which can be retrieved from memory. For instance, in the given example of the business application previously processed travel vouchers for travel reimbursement and variations thereof can be used as the test input data 284. By way of example, the exemplary expense account of Table I and variations thereof can be used as the test input data 284 in the given example. In one embodiment, the test input data 284 is generated based on an input data schema and corresponding input data constraints. The input data schema describes input data that is suitable as input to the data driven software system. The input data constraints are suitable to establish boundaries on possible permutations of the test input data 284. By way of example, the input data schema may generically define suitable expense accounts and the input data constraints may define constraints on values which are allowed in a corresponding test expense account. Generation of the test configuration data 282 is described in more detail below with reference to FIGS. 3-6B.

### An Exemplary Test Configuration Data Generation Process

Referring now to FIG. 3, an exemplary method 300 for generation of test configuration data (e.g., test configuration data 282 of FIG. 2B) in one embodiment is shown. At least part of the steps of method 300 can be performed by a suitable test data generator (e.g., test data generator 270 of FIG. 2B). The method 300 starts at step 310.

At step 320, an underlying configuration schema (e.g., configuration schema 232 of FIG. 2B) which is suitable for definition of the test configuration data is retrieved and evaluated. In one embodiment, evaluating the underlying configuration schema includes identifying all configuration items (e.g., configuration items 234 of FIG. 2B) defined by the underlying configuration schema. An exemplary method of evaluating the underlying configuration schema is described below with reference to FIGS. 4A-B.

At step 330, a set of constraints (e.g., configuration item constraints 260 of FIG. 2B) which is suitable to establish boundaries on possible permutations of the test configuration data is retrieved and processed. In one embodiment, processing the set of constraints includes identifying constraints on at least a portion of the identified configuration items. An exemplary method of processing the set of constraints is described below with reference to FIGS. 5A-B.

At step 340, a test configuration data output structure is generated on the basis of the identified configuration items and the processed set of constraints. An exemplary method of generating the test configuration data output structure is described below with reference to FIGS. 6A-B. Method 300 then exits at step 350.

Referring now to FIGS. 4A-B, an exemplary method 400 of evaluating the underlying configuration schema according to step 320 of the method 300 of FIG. 3 is shown. By way of example, the exemplary method 400 is described in more detail with reference to the illustrative business application configuration schema of Table IV which exemplifies the configuration schema 232 of FIG. 2B. In the given example, the illustrative business application configuration schema defines all configuration items required for generation of the test configuration data. At least part of the steps of method 400 can be performed by a suitable test data generator (e.g., test data generator 270 of FIG. 2B).

The method 400 starts at step 410, where a loop consisting of steps 410 to 455 is entered for each underlying configuration schema. In the given example, the loop is initially entered for the exemplary business application configuration schema.

At step 415, the business application configuration schema is analyzed to identify all configuration items thereof. By way of example, as was noted above the configuration item “operator” can be identified from line 053 of Table IV, the configuration item “attribute” can be identified from line 052 of Table IV, and the configuration item “value” can be identified from line 068 of Table IV.

At step 420, a loop consisting of steps 420 to 455 is entered for each identified configuration item of the business application schema. By way of example, assume that the loop is initially entered for the configuration item “operator”.

At step 430, it is determined from the business configuration application schema whether the configuration item “operator” is a required configuration item. If the configuration item “operator” is not required, it is classified as optional. In this case, a corresponding record is created at step 432 which marks the configuration item “operator” as optional. Processing then continues at step 440. However, in the given example the configuration item “operator” is a required item according to the business application configuration schema (use=“required” in line 053 of Table IV). Accordingly, a corresponding record is created at step 434 which marks the configuration item “operator” as required. Processing then continues at step 440.

At step 440, it is determined from the business configuration application schema whether a maximum allowed number of instances of the configuration item “operator” in the test configuration data is defined. If a maximum number is defined for the configuration item “operator”, a corresponding record is created at step 445 which associates the item with the defined maximum number. Processing then continues at step 450. However, in the given example no maximum number is defined in lines 053-067 of Table IV for the configuration item “operator”. Accordingly, no record is created at step 445 and processing continues at step 450.

At step 450, it is determined whether the configuration item “operator” is associated with a list or pattern of allowed values. If the configuration item “operator” is not associated with a list or pattern of allowed values, processing returns to step 420. However, according to lines 056-064 of Table IV, the business configuration application schema restricts possible values for the configuration item “operator” to the values “EQ”, “NE”, “GT”, “LT”, “GE”, “LE”, “EXISTS”, “OR”, and “AND”. These values are recorded at step 455 with respect to the configuration item “operator”. Processing then returns to step 420, where the loop consisting of steps 420 to 455 is entered for a next identified configuration item. For instance, in the given example the loop can be entered for the configuration item “attribute”.

When all identified configuration items of the business configuration application schema have been processed according to the loop consisting of steps 420 to 455, processing returns to step 410, where the loop consisting of steps 410 to 455 is entered for a next configuration schema. As in the given example only the single business configuration application schema needs to be processed, processing continues at step 330 of the method 300 of FIG. 3.

Referring now to FIGS. 5A-B, an exemplary method 500 of processing the set of constraints according to step 330 of the method 300 of FIG. 3 is shown. By way of example, the exemplary method 500 is described in more detail with reference to the exemplary business application constraints of Table V which exemplify the configuration item constraints 260 of FIG. 2B. As was noted above, the exemplary business application constraints are configured to establish boundaries on possible permutations of the test configuration data. At least part of the steps of method 500 can be performed by a suitable test data generator (e.g., test data generator 270 of FIG. 2B).

The method 500 starts at step 510, where the exemplary business application constraints are evaluated to identify all defined constraints for each identified configuration item therefrom. As was noted above, the constraints on the configuration items “operator” (lines 007-012 of Table V), “attribute” (lines 013-017 of Table V), “type” (lines 018-022 of Table V), and “Reviewer” (lines 023-025 of Table V) can be identified in the given example.

At step 520, a loop consisting of steps 520 to 595 is entered for each identified configuration item. By way of example, assume that the loop is initially entered for the configuration item “operator”.

At step 522, it is determined whether the configuration item “operator” is a significant item. If the configuration item “operator” is not a significant item, processing returns to step 520, where the loop consisting of steps 520 to 595 is entered for a next configuration item. However, as was noted above, the configuration item “operator” is a significant item in the given example according to line 007 of Table V (significant=“true”). Accordingly, the configuration item “operator” is marked as significant at step 524 and processing continues at step 530. In one embodiment, marking the configuration item “operator” as significant can be performed using any suitable, known or unknown, technique including setting a corresponding significant flag.

At step 530, it is determined whether the defined constraints of the configuration item “operator” include a possible value constraint. If the defined constraints do not include a possible value constraint, processing continues at step 540. However, in the given example the configuration item “operator” is associated with a possible value constraint (“ValueListConstraint”) according to lines 008-011 of Table V. The possible value constraint defines as possible values for the configuration item “operator” the values “EQ” and “GT” (lines 009-010 of Table V). Accordingly, these possible values are set for the configuration item “operator” in the test configuration data at step 535. Processing then continues at step 540.

At step 540, it is determined whether the defined constraints of the configuration item “operator” include a depth of recursion constraint. If the defined constraints include a depth of recursion constraint, a required depth of recursion is determined therefrom. At step 545, the identified depth of recursion is set for the configuration item “operator” in the test configuration data and processing continues at step 550. However, in the given example the defined constraints do not include a depth of recursion constraint for the configuration item “operator”. Accordingly, processing continues at step 550 without performing step 545.

At step 550, it is determined whether the defined constraints of the configuration item “operator” include a coexistence constraint. If the defined constraints include a coexistence constraint, a corresponding coexistence relation between the configuration item “operator” and another configuration item is determined therefrom. At step 555, the identified coexistence relation is set for the configuration item “operator” in the test configuration data and processing continues at step 560. However, in the given example the defined constraints do not include a coexistence constraint for the configuration item “operator”. Accordingly, processing continues at step 560 without performing step 555.

At step 560, it is determined whether the defined constraints of the configuration item “operator” include a value equivalency constraint. If the defined constraints include a value equivalency constraint, a required relationship between one or more values of the configuration item “operator” and corresponding values of another configuration item(s) is determined therefrom. At step 565, the identified relationship is set for the configuration item “operator” in the test configuration data and processing continues at step 570. However, in the given example the defined constraints do not include a value equivalency constraint for the configuration item “operator”. Accordingly, processing continues at step 570 without performing step 565.

At step 570, it is determined whether the defined constraints of the configuration item “operator” include a cardinality constraint. If the defined constraints include a cardinality constraint, an allowed upper and lower bound of a number of instances of the configuration item “operator” in the test configuration data is determined therefrom. At step 575, at least one of the identified upper and lower bounds is set for the configuration item “operator” in the test configuration data and processing continues at step 580. However, in the given example the defined constraints do not include a cardinality constraint for the configuration item “operator”. Accordingly, processing continues at step 580 without performing step 575.

For purposes of illustration, it should be noted that the configuration item “reviewer” (lines 023-025 of Table V) is associated with a cardinality constraint according to line 024 of Table V (CardinalityConstraint max=“2” min=“0”). This cardinality constraint defines a lower bound of “0” instances (min=“0”) and an upper bound of “2” instances (max=“2”) of the configuration item “reviewer” in the test configuration data. Accordingly, at least one of the upper and lower bounds is set for the configuration item “reviewer” at step 575.

At step 580, it is determined whether the defined constraints of the configuration item “operator” include a boundary identifier constraint. If the defined constraints include a boundary identifier constraint, corresponding boundaries of possible values of the configuration item “operator” in the test configuration data are determined therefrom. At step 585, the identified boundaries are set for the configuration item “operator” in the test configuration data and processing continues at step 590. However, in the given example the defined constraints do not include a boundary identifier constraint for the configuration item “operator”. Accordingly, processing continues at step 590 without performing step 585.

At step 590, it is determined whether the defined constraints of the configuration item “operator” include another type of constraint. If the defined constraints include another type of constraint, a suitable processing is performed at step 595 and processing then returns to step 520. However, in the given example the defined constraints do not include any other constraint for the configuration item “operator”. Accordingly, processing returns to step 520 without performing step 595, where the loop consisting of steps 520 to 595 is entered for a next identified configuration item. For instance, the loop can be entered for the configuration item “attribute” in the given example.

When all identified configuration items of the business configuration application schema have been processed according to the loop consisting of steps 520 to 595, processing continues at step 340 of the method 300 of FIG. 3.

Referring now to FIGS. 6A-B, an exemplary method 600 of generating a test configuration data output structure according to step 340 of the method 300 of FIG. 3 is shown. By way of example, the exemplary method 600 is described in more detail with reference to a test configuration data output structure (e.g., test configuration data 282 of FIG. 2B) which is suitable for testing the business application of the given example. At least part of the steps of method 600 can be performed by a suitable test data generator (e.g., test data generator 270 of FIG. 2B).

The method 600 starts at step 610, where all significant configuration items are identified. In other words, all configuration items which have been marked as “significant” at step 524 of FIGS. 5A-B are identified. As was noted above with reference to Table V, the configuration items “operator”, “attribute”, “type”, and “Reviewer” are marked as significant identifiers in the given example and, thus, identified at step 610.

At step 620, the exemplary business application constraints are used to determine a number of desired permutations of corresponding rules in the test configuration data. In one embodiment, this determination is performed using the settings according to steps 535, 545, 555, 565, 575, 585 and 595 of the method 500 of FIGS. 5A-B. In the given example, two possible values of the configuration item “operator” and zero, one or two instances of the configuration item “reviewer” may occur in the test configuration data. Accordingly, six permutations can be created, each defining a different rule in the test configuration data.

At step 630, values are arbitrarily associated to all non-significant configuration items. More specifically, according to steps 430 and 434 of FIGS. 4A-B configuration items can be recorded as being “required” without being marked as being “significant” at step 524 of FIGS. 5A-B. These configuration items are nevertheless required to define valid test configuration data. For instance, according to lines 022-025 of the exemplary business application configuration schema of Table IV, the configuration items “name” and “emailAddress” of a given reviewer are required for definition of the test configuration data. However, as can be seen from Table V, these configuration items have not been included with the business application constraints as significant configuration items. By way of example, assume that the name “Fred Smith” and the e-mail address “fsmith@mycompany.net” are associated with a first reviewer and that the name “Bill Penney” and the e-mail address “bp@mycompany.net” are associated with a second reviewer.

At step 640, an empty test configuration data output structure is created which defines a current output structure. In the given example, the empty test configuration data output structure can be defined using lines 001-004 and 037 of the exemplary business application configuration data of Table III. In other words, the empty test configuration data output structure includes all required general information for the test configuration data without any particular rules.

At step 650, a loop consisting of steps 650 to 680 is entered for each possible permutation of significant configuration items. For instance, assume that the loop is initially entered for a first permutation including as selected significant configuration items “operator” having the value “EQ”, “attribute” having the value “totamount” and “type” having the value “review”, but with “0” instances of the significant configuration item “reviewer”.

At step 660, all selected significant configuration items of the first permutation are combined with optional configuration items into an item combination. By way of example, the selected significant configuration items are combined with the optional configuration item “value” having the value “100”.

At step 670, it is determined whether a maximum number of any configuration item has been reached in the current output structure. For instance, a maximum number of instances of the configuration item “operator” could have been reached in the current output structure. In this case, the current output structure is stored as a persistent data object at step 672 and another empty test configuration data output structure is created at step 674. Processing then continues at step 680. However, if such a maximum number has not been reached, a corresponding rule is created on the basis of the item combination and written to the current output structure at step 680. Illustratively, the exemplary rule shown in Table VII below is created and written to the current output structure. By way of illustration, the illustrative rule is defined using XML. However, any other language may be used to advantage. For brevity, a detailed description of the exemplary rule is omitted as corresponding rules have been described in more detail above with reference to Table III.

TABLE VII
RULE EXAMPLE

001 − <ExpenseRule>
002 <Condition operator=“EQ” attribute=“totAmount” value=“100” />
003 <Action type=“review” />
004 </ExpenseRule>

Processing then returns to step 650, where the loop consisting of steps 650 to 680 is entered for a next permutation of significant configuration items. When all possible permutations have been processed according to the loop consisting of steps 650 to 680, generation of the rules required for the test configuration data output structure is completed. Processing then continues at step 690.

At step 690, the current output structure is stored as a persistent data object defining the test configuration data (e.g., test configuration data 282 of FIG. 2B) which is suitable for testing the underlying data driven software system (e.g., data driven software system 230 of FIG. 2B). Processing then continues at step 350 of FIG. 3.

In the given example, business application test configuration data for testing the business application is generated. Exemplary business application test configuration data is shown in Table VIII below. By way of illustration, the illustrative business application test configuration data is defined using XML. However, any other language may be used to advantage. Furthermore, it should be noted that the exemplary business application test configuration data is in structure and layout similar to the illustrative business application configuration data of Table III. Therefore, a detailed description thereof is omitted, for brevity.

TABLE VIII
BUSINESS APPLICATION TEST CONFIGURATION DATA
EXAMPLE

001 <?xml version=“1.0” encoding=“UTF-8” ?>
002 − <e:ExpenseProcess xmlns:e=“http://www.mycompany.com”
003 xmlns:xsi=“http://www.w3.org/2001/XMLSchema-instance”
004 xsi:schemaLocation=“http://www.mycompany.com ExpenseProcess.xsd”>
005 − <ExpenseRule>
006 <Condition operator=“EQ” attribute=“totAmount” value=“100” />
007 <Action type=“review” />
008 </ExpenseRule>
009 − <ExpenseRule>
010 <Condition operator=“EQ” attribute=“totAmount” value=“100” />
011 − <Action type=“review”>
012 <Reviewer name=“Fred Smith”
013 emailAddress=“fsmith@mycompany.net” />
014 </Action>
015 </ExpenseRule>
016 − <ExpenseRule>
017 <Condition operator=“EQ” attribute=“totAmount” value=“100” />
018 − <Action type=“review”>
019 <Reviewer name=“Fred Smith”
020 emailAddress=“fsmith@mycompany.net” />
021 <Reviewer name=“Bill Penney”
022 emailAddress=“bp@mycompany.net” />
023 </Action>
024 </ExpenseRule>
025 − <ExpenseRule>
026 <Condition operator=“GT” attribute=“totAmount” value=“100” />
027 <Action type=“review” />
028 </ExpenseRule>
029 − <ExpenseRule>
030 <Condition operator=“GT” attribute=“totAmount” value=“100” />
031 − <Action type=“review”>
032 <Reviewer name=“Fred Smith”
033 emailAddress=“fsmith@mycompany.net” />
034 </Action>
035 </ExpenseRule>
036 − <ExpenseRule>
037 <Condition operator=“GT” attribute=“totAmount” value=“100” />
038 − <Action type=“review”>
039 <Reviewer name=“Fred Smith”
040 emailAddress=“fsmith@mycompany.net” />
041 <Reviewer name=“Bill Penney”
042 emailAddress=“bp@mycompany.net” />
043 </Action>
044 </ExpenseRule>
045 </e:ExpenseProcess>

It should be noted that the rule defined in lines 005-008 of Table VIII corresponds to the exemplary rule of Table VII above. Furthermore, six rules (lines 005-008, 009-015, 016-024, 025-028, 029-035 and 036-044) have been created, one for each possible permutation of the significant configuration items.

### CONCLUSION

In various embodiments, the invention provides numerous advantages over the prior art. For instance, according to embodiments of the invention at least one and possibly many test configuration data sets can be generated automatically based on underlying configuration schemas and provided configuration item constraints. Multiple test configuration data sets would have to be produced in situations where an underlying configuration schema does not support a required number of permutations of a given configuration item required to achieve complete test coverage.

While the foregoing is directed to embodiments of the present invention, other and further embodiments of the invention may be devised without departing from the basic scope thereof, and the scope thereof is determined by the claims that follow.

What is claimed is:

1. A computer-implemented method of creating test data configured for testing a data driven software system, comprising:
retrieving a configuration schema describing structure and layout of configuration data suitable for driving the software system;
retrieving a set of constraints suitable to establish boundaries on possible permutations of the configuration data; and
generating the test data on the basis of the configuration schema and the set of constraints.

2. The method of claim 1, wherein generating the test data on the basis of the configuration schema and the set of constraints comprises:
generating a given number of permutations of the configuration data, the given number being determined on the basis of the retrieved set of constraints, wherein the permutations of the configuration data define the test data.

3. The method of claim 1, further comprising:
testing the data driven software system using the generated test data.

4. The method of claim 1, further comprising:
identifying, from the configuration schema, a set of configuration items supported by the data driven software system, the set of configuration items defining the structure and layout of the configuration data; and
associating the set of configuration items with corresponding constraints of the set of constraints.

5. The method of claim 4, further comprising:
identifying one or more possible value constraints from the set of constraints, each identifying a possible set of values for a given configuration item of the configuration schema in the test data.

6. The method of claim 4, further comprising:
identifying one or more depth of recursion constraints from the set of constraints, each identifying a required depth of recursion for the test data.

7. The method of claim 4, further comprising:
identifying one or more coexistence constraints from the set of constraints, each identifying a required coexistence of two different configuration items in the test data.

8. The method of claim 4, further comprising:
identifying one or more value equivalency constraints from the set of constraints, each identifying a required relationship between values of different configuration items.

9. The method of claim 4, further comprising:
identifying one or more cardinality constraints from the set of constraints, each identifying an allowed upper bound of a number of instances of a given configuration item in the test data.

10. The method of claim 4, further comprising:
identifying one or more boundary identifiers from the set of constraints, each identifying boundaries of a possible set of values for a given configuration item of the configuration schema in the test data.

11. The method of claim 4, further comprising:
identifying one or more significant element identifiers from the set of constraints, each identifying one or more significant configuration items of the configuration schema that affect runtime behavior of the data driven software system.

12. The method of claim 11, wherein generating the test data on the basis of the configuration schema and the set of constraints comprises:
generating a given number of permutations of the configuration data, the given number being determined on the basis of the retrieved set of constraints for each of the one or more significant configuration items, wherein the permutations of the configuration data define the test data.

13. A computer-readable medium containing a program which, when executed by a processor, performs operations for creating test data configured for testing a data driven software system, the operations comprising:
retrieving a configuration schema describing structure and layout of configuration data suitable for driving the software system;
retrieving a set of constraints suitable to establish boundaries on possible permutations of the configuration data; and
generating the test data on the basis of the configuration schema and the set of constraints.

14. The computer-readable medium of claim 13, wherein generating the test data on the basis of the configuration schema and the set of constraints comprises:
generating a given number of permutations of the configuration data, the given number being determined on the basis of the retrieved set of constraints, wherein the permutations of the configuration data define the test data.

15. The computer-readable medium of claim 13, wherein the operations further comprise:
testing the data driven software system using the generated test data.

16. The computer-readable medium of claim 13, wherein the operations further comprise:
identifying, from the configuration schema, a set of configuration items supported by the data driven software system, the set of configuration items defining the structure and layout of the configuration data; and
associating the set of configuration items with corresponding constraints of the set of constraints.

17. The computer-readable medium of claim 16, wherein the set of constraints comprises at least one of:
(i) one or more possible value constraints from the set of constraints, each identifying a possible set of values for a given configuration item of the configuration schema in the test data;
(ii) one or more depth of recursion constraints from the set of constraints, each identifying a required depth of recursion for the test data;
(iii) one or more coexistence constraints from the set of constraints, each identifying a required coexistence of two different configuration items in the test data;
(iv) one or more value equivalency constraints from the set of constraints, each identifying a required relationship between values of different configuration items;
(v) one or more cardinality constraints from the set of constraints, each identifying an allowed upper bound of a number of instances of a given configuration item in the test data; and
(vi) one or more boundary identifiers from the set of constraints, each identifying boundaries of a possible set of values for a given configuration item of the configuration schema in the test data.

18. The computer-readable medium of claim 16, wherein the operations further comprise:
identifying one or more significant element identifiers from the set of constraints, each identifying one or more significant configuration items of the configuration schema that affect runtime behavior of the data driven software system.

19. The computer-readable medium of claim 18, wherein generating the test data on the basis of the configuration schema and the set of constraints comprises:
generating a given number of permutations of the configuration data, the given number being determined on the basis of the retrieved set of constraints for each of the one or more significant configuration items, wherein the permutations of the configuration data define the test data.

20. A system for creating test data configured for testing a data driven software system, comprising:
a configuration schema describing structure and layout of configuration data suitable for driving the software system;
a set of constraints suitable to establish boundaries on possible permutations of the configuration data; and
a test data generator configured to generate the test data on the basis of the configuration schema and the set of constraints.
